(19) United States
(12) Patent Application Publication
(10) Pub. No.: US 2026/0246147 A1
(43) Pub. Date: Aug. 20, 2026

(54) SURFACE MOUNT STACKED PATCH ANTENNA MODULE AND METHODS OF MANUFACTURING THE SAME

(71) Applicant: TAOGLAS GROUP HOLDINGS LIMITED, Enniscorthy (IE)

(72) Inventors: Baha Badran, Enniscorthy (IE); Hemin Ismael Azeez, Taoyuan City (TW); Adam Tseng, Taoyuan City (TW); Amos Huang, Taoyuan City (TW)

(21) Appl. No.: 19/454,817

(22) Filed: Jan. 21, 2026

Related U.S. Application Data
(60) Provisional application No. 63/759,808, filed on Feb. 18, 2025.

(51) Int. Cl. H01Q 9/04

(52) U.S. Cl. CPC H01Q 9/0414

(57) ABSTRACT

A patch antenna module as well as methods of manufacturing the patch antenna module. In one embodiment, the patch antenna module includes one or more patch antennas; a through-hole to surface mount printed circuit board, the through-hole to surface mount printed circuit board being placed in signal communication with the one or more patch antennas via a through-hole patch antenna terminal; a spacer printed circuit board having an internal cavity disposed therein, the spacer printed circuit board being placed in signal communication with the one or more patch antennas via a surface mount electrical connection; and an external connection printed circuit board having a plurality of electronic components disposed thereon, the internal cavity of the spacer printed circuit board accommodating at least a portion of the plurality of electronic components disposed on the external connection printed circuit board.

### CROSS-REFERENCE TO RELATED APPLICATIONS

This application claims the benefit of priority to U.S. Provisional Patent Application Ser. No. 63/759,808 filed Feb. 18, 2025, entitled “Surface Mount Stacked Patch Antenna Module”, the contents of which being incorporated herein by reference in its entirety.

### FIELD

The present disclosure relates generally to surface mount stacked patch antenna modules, and more particularly in one exemplary aspect to surface mount stacked patch antenna modules with integrated passive or active radio frequency (RF) modules.

### BACKGROUND

Microstrip antennas (e.g., patch antennas, chip antennas, etc.) are telecommunication devices that are typically fabricated using photolithographic techniques that consist of one or more layers of metal disposed on an underlying substrate. These microstrip antennas are typically deployed over a metallic ground plane and connected with a transmitter and/or receiver (e.g., an RF module) via microstrip transmission lines. The RF module is typically separately sourced from the underlying antenna. This may result in time and resource consuming research and development for the antenna to function as intended. Additionally, the RF module typically takes up additional real estate on the system level printed circuit board (PCB) in addition to the real estate occupied by the underlying antenna, resulting in larger system level devices. Accordingly, new techniques are needed that address these known limitations associated with the acquisition and deployment of these microstrip antennas.

### SUMMARY

The present disclosure satisfies the foregoing needs by providing, inter alia, methods, apparatus and systems for the implementation of microstrip antennas with integrated RF modules.

In one aspect, a patch antenna module is disclosed. In one embodiment, the patch antenna module, includes: one or more patch antennas; a through-hole to surface mount printed circuit board, the through-hole to surface mount printed circuit board being placed in signal communication with the one or more patch antennas via a through-hole patch antenna terminal; a spacer printed circuit board having an internal cavity disposed therein, the spacer printed circuit board being placed in signal communication with the one or more patch antennas via a surface mount electrical connection; and an external connection printed circuit board having a plurality of electronic components disposed thereon, the internal cavity of the spacer printed circuit board accommodating at least a portion of the plurality of electronic components disposed on the external connection printed circuit board.

In one variant, the external connection printed circuit board includes surface mount pads for connecting the patch antenna module to an external system level device.

In another variant, the spacer printed circuit board includes a feed structure with a castellated hole, the through-hole patch antenna terminal being mounted within the castellated hole such that the through-hole patch antenna terminal only partially penetrates a thickness of the feed structure.

In yet another variant, the one or more patch antennas includes a top patch antenna and a bottom patch antenna, an external periphery of the top patch antenna being smaller in dimension than an external periphery of the bottom patch antenna.

In yet another variant, a thickness of the top patch antenna is smaller in dimension than a thickness of the bottom patch antenna.

In yet another variant, the electronic components include a passive radio frequency module.

In yet another variant, the electronic components include an active radio frequency module.

In yet another variant, the through-hole to surface mount printed circuit board includes a through-hole termination disposed in a central region of the through-hole to surface mount printed circuit board, the through-hole termination being configured to receive the through-hole patch antenna terminal.

In yet another variant, the through-hole to surface mount printed circuit board includes an antenna feed trace, the antenna feed trace being in signal communication with the through-hole termination, the antenna feed trace extending from the through-hole termination to an end of the through-hole to surface mount printed circuit board.

In yet another variant, a portion of the antenna feed trace disposed adjacent to the end of the through-hole to surface mount printed circuit board is in signal communication with a termination on a top surface of the spacer printed circuit board.

In yet another variant, the termination on the top surface of the spacer printed circuit board is in electrical communication with a termination on a bottom surface of the spacer printed circuit board.

In yet another variant, the electrical communication between the termination on the top surface of the spacer printed circuit board and the termination on the bottom surface of the spacer printed circuit board includes a trace disposed on a surface of the internal cavity of the spacer printed circuit board that connects the termination on the top surface with the termination on the bottom surface of the spacer printed circuit board.

In another aspect, a method of manufacturing a patch antenna module is disclosed. In one embodiment, the method includes acquiring a patch antenna, a through-hole to surface mount printed circuit board, a spacer printed circuit board, and an external connection printed circuit board; assembling the patch antenna with the through-hole to surface mount printed circuit board via use of a through-hole patch antenna terminal to create a first sub-assembly; assembling the spacer printed circuit board to the external connection printed circuit board via a solder reflow process to create a second sub-assembly; and assembling the first sub-assembly with the second sub-assembly using a soldering operation.

In yet another aspects, components of the aforementioned patch antenna module are disclosed.

Other features and advantages of the present disclosure will immediately be recognized by persons of ordinary skill in the art with reference to the attached drawings and detailed description of exemplary implementations as given below.

### BRIEF DESCRIPTION OF DRAWINGS

The features, objectives, and advantages of the present disclosure will become more apparent from the detailed description set forth below when taken in conjunction with the drawings, wherein:

FIG. 1A is a top exploded perspective view of an exemplary pin-mount to surface mount stacked patch antenna module, in accordance with the principles of the present disclosure.

FIG. 1B is a bottom exploded perspective view of the antenna module of FIG. 1A, in accordance with the principles of the present disclosure.

FIG. 1C is a bottom exploded perspective view of the stacked printed circuit board used in the antenna module of FIG. 1A, in accordance with the principles of the present disclosure.

FIG. 1D is a bottom perspective view of an alternative through hole termination technique, in accordance with the principles of the present disclosure.

FIG. 1E is a front plan view of the antenna module of FIG. 1A, in accordance with the principles of the present disclosure.

FIG. 2A is a top perspective view of another exemplary stacked patch antenna module, in accordance with the principles of the present disclosure.

FIG. 2B is a top exploded perspective view of the exemplary stacked patch antenna module of FIG. 2A, in accordance with the principles of the present disclosure.

All Figures disclosed herein are © Copyright 2025 Taoglas Group Holdings Limited. All rights reserved.

### DESCRIPTION

Detailed descriptions of the various embodiments and variants of the apparatus and methods of the present disclosure are now provided. It is noted that wherever practicable similar or like reference numbers may be used in the figures and may indicate similar or like functionality. The figures depict embodiments of a stacked patch antenna module as well as exemplary methods of installation and use of these stacked patch antenna modules for purposes of illustration only. One skilled in the art will readily recognize from the following description that alternative embodiments of the structures and methods illustrated may be employed without necessarily departing from the principles described herein.

### Exemplary Stacked Patch Antenna Modules

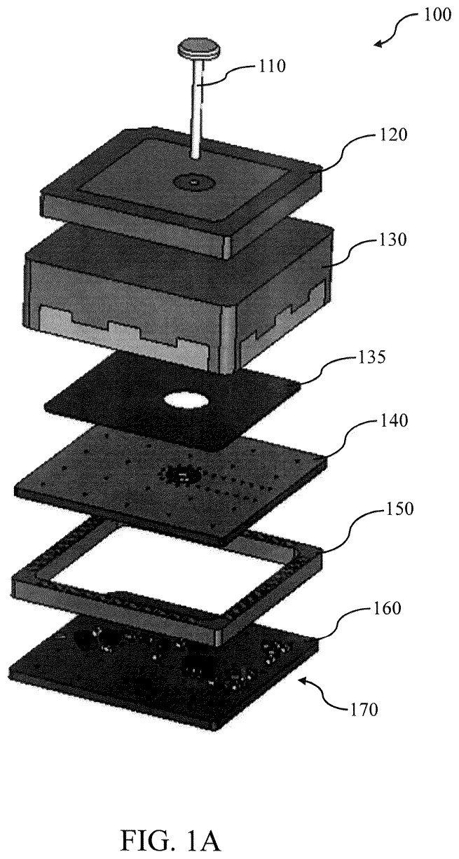

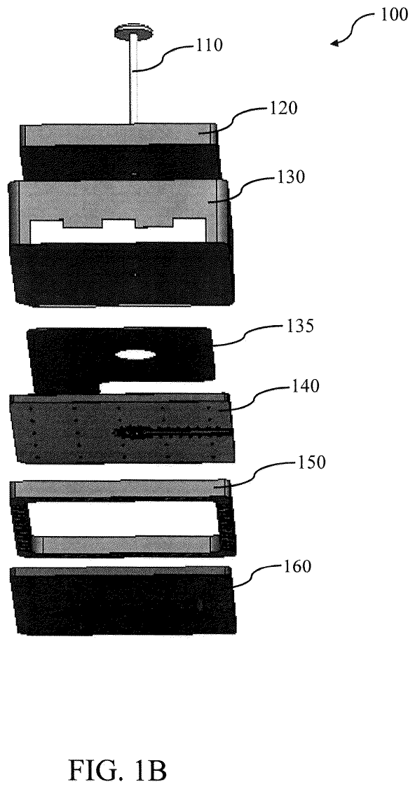

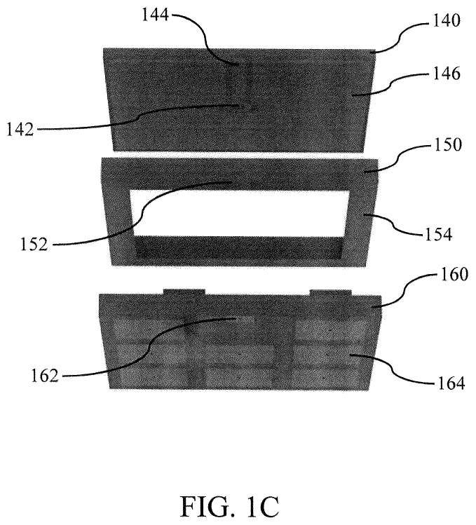

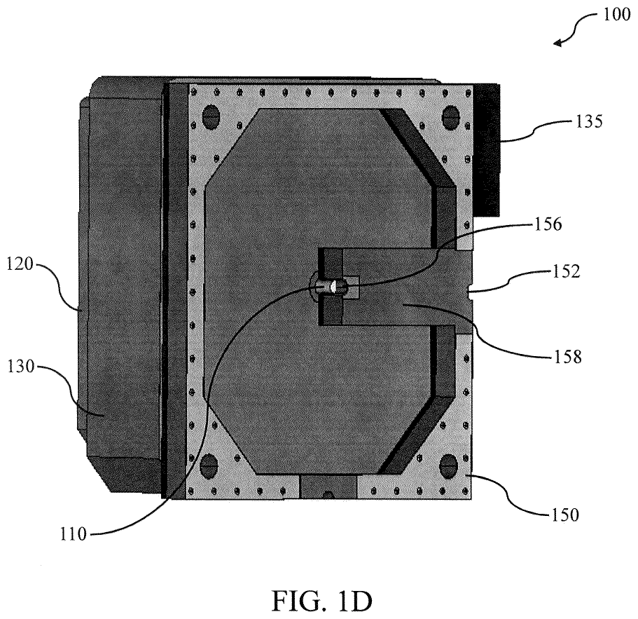

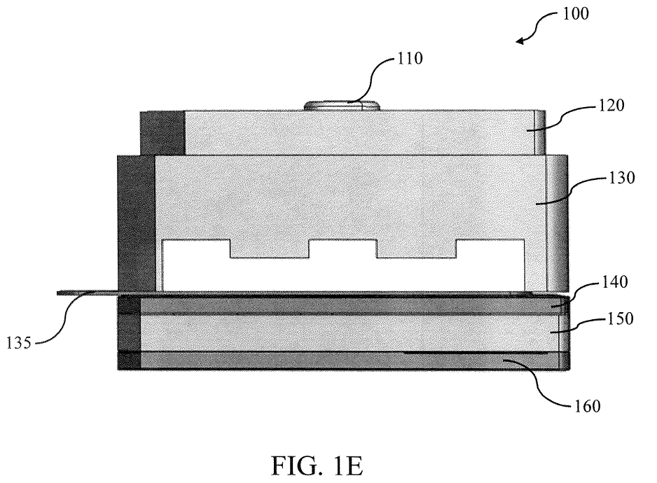

Referring now to FIGS. 1A and 1B, an exploded perspective view of an exemplary pin-mount to surface mount stacked patch antenna module 100 is shown and described in detail, while FIG. 1E is a front plan view of the antenna module 100 in a non-exploded view. The exemplary pin-mount to surface mount stacked patch antenna module 100 includes a number of components including a through-hole patch antenna terminal 110, a top patch antenna 120, a bottom patch antenna 130, double-sided adhesive 135, a through-hole to surface mount printed circuit board (PCB) 140, a surface mount to surface mount spacer PCB 150, and an external connection PCB 160 having a number of electronic components 170 disposed thereon. The electronic components 170 disposed on, for example, the external connection PCB 160 may consist of active and/or passive electronic components 170. These active and/or passive electronic components 170 may operate as the RF module circuitry for the patch antennas 120, 130. The RF module circuitry may be used as transmission and/or reception circuitry for the patch antennas 120, 130. The through-hole to surface mount printed circuit board (PCB) 140, surface mount to surface mount spacer PCB 150, and the external connection PCB 160 may be manufactured from a rigid or semi-rigid PCB.

As a brief aside, while the pin-mount to surface mount stacked patch antenna module 100 is shown with two patch antennas (namely, the top patch antenna 120 and the bottom patch antenna 130), it would be readily apparent to one of ordinary skill given the contents of the present disclosure that the number of patch antennas could be fewer (e.g., one patch antenna) in number, or may consist of three (or more) patch antennas in some implementations. In some implementations, the patch antennas illustrated may be obviated in favor of surface mountable chip antenna structures. The antennas (whether a patch antenna or a chip antenna) may be designed to operate in frequency bands associated with one or more of: Bluetooth®, Wi-Fi®, Zigbee®, global navigation satellite system (GNSS), dedicated short-range communications (DSRC), vehicle-to-everything (V2X), L-band, S-band, cellular, and various internet of things (IoT) communication protocols, etc. The patch antennas may include any of the structures disclosed in U.S. Pat. No. 11,139,550 issued Oct. 5, 2021, and entitled “Stack Antenna Structures and Methods”, the contents of which being incorporated herein by reference in its entirety. The patch antennas may also include any of the antenna structures disclosed in U.S. patent application Ser. No. 18/664,588 filed May 15, 2024, and entitled “Building Block Antenna Structures and Methods”, the contents of which being incorporated herein by reference in its entirety. These and other variations on antenna design would be readily apparent to one of ordinary skill given the contents of the present disclosure.

Returning to FIGS. 1A and 1B, the exemplary pin-mount to surface mount stacked patch antenna module 100 is assembled using both through-hole soldering techniques (e.g., wave soldering processes) as well as surface mount soldering techniques such as, for example, a solder reflow process. For example, the patch antennas 120, 130 are secured to the through-hole to surface mount PCB 140 by soldering the through-hole patch antenna terminal 110 to the through-hole to surface mount PCB 140. The electronic components 170 (or portions thereof) are secured to the external connection PCB 160 using, for example, a surface mount soldering process such as a solder reflow process. The through-hole to surface mount PCB 140, the surface mount to surface mount spacer PCB 150, and the external connection PCB 160 may be secured to each other using a surface mount soldering process such as, for example, a solder reflow process. For example, a first step may be to secure the patch antennas 120, 130 to the through-hole to surface mount PCB 140 by soldering the through-hole patch antenna terminal 110 to the through-hole to surface mount PCB 140. A second step may be to secure the surface mount to surface mount spacer PCB 150 with the external connection PCB 160 using, for example, a surface mount soldering process. A third step may be to secure these subassemblies created in steps one and two to each other using, for example, a surface mount soldering process. In some implementations, the through-hole patch antenna terminal 110 is secured to the top patch antenna 120 using an adhesive which fixes the through-hole patch antenna terminal 110 to the top patch antenna 120 during surface mount reflow processes. The use of this adhesive advantageously does not increase the overall height of the pin-mount to surface mount stacked patch antenna module 100. Additionally, the double-sided adhesive 135 may assist in securing the patch antennas 120, 130 to the through-hole to surface mount PCB 140 during surface mount reflow processes. However, in some implementations, the double-sided adhesive 135 may be obviated from the design.

Referring now to FIG. 1C, the stacked PCB structure is shown and described in detail. The through-hole to surface mount PCB 140 includes a through-hole termination 142 for receiving the through-hole patch antenna terminal 110. While a single through-hole termination 142 is illustrated in FIG. 1C, it would be readily apparent to one of ordinary skill given the contents of the present disclosure that two or more through-hole terminations 142 may be present on the through-hole to surface mount PCB 140 dependent on the specific configuration of the patch antennas on the design, or dependent on whether any through-hole electronic components 170 are disposed on the through-hole to surface mount PCB 140. The through-hole to surface mount PCB 140 also includes an antenna feed trace 144 that runs from a central portion of the through-hole to surface mount PCB towards an edge of the through-hole to surface mount PCB 140. The through-hole to surface mount PCB 140 also includes a through-hole to surface mount PCB ground plane 146. As shown in FIG. 1C, the external perimeter of the through-hole to surface mount PCB 140 is square in shape. However, other variations for the through-hole to surface mount PCB 140 may have a rectangular profile, a triangular profile, a circular profile, various convex polygonal profiles (e.g., octagonal, irregular convex polygon, hexagonal, etc.) and the like. These and other variations would be readily apparent to one of ordinary skill given the contents of the present disclosure. The through-hole to surface mount PCB 140 may consist of two (or more) layers of conductive material. For example, the through-hole to surface mount PCB 140 may consist of four layers of conductive material.

In some implementations, the through-hole to surface mount PCB 140 may have electronic components 170 disposed thereon. For example, one or more electronic components 170 may be disposed on the top side and/or the bottom side of the through-hole to surface mount PCB 140. For example, one or more electronic components 170 may be placed on the lower side of the through-hole to surface mount PCB 140 within the central opening of the surface mount to surface mount spacer PCB 150. In such an implementation, the one or more electronic components 170 placed on the bottom side of the through-hole to surface mount PCB 140 may have a height less than the thickness of the surface mount to surface mount spacer PCB 150. In instances in which the one or more electronic components 170 are placed on the top side of the through-hole to surface mount PCB 140, the height of the one or more electronic components 170 may be less than the height of the bottom patch antenna 130. In some implementations, the thickness of the through-hole to surface mount PCB 140 may be between 0.4 mm and 1.6 mm, although thicknesses less than 0.4 mm and greater than 1.6 mm may be used in some variants. Moreover, and as shown in FIGS. 1A and 1B, the through-hole to surface mount PCB 140 may have an external perimeter that is larger in dimension than both the top patch antenna 120 and the bottom patch antenna 130.

The surface mount to surface mount spacer PCB 150 provides a clearance area to accommodate the electronic components 170 disposed on the external connection PCB 160, while also ensuring that the through-hole patch antenna terminal 110 does not contact the electronic components 170 disposed on the external connection PCB 160. The antenna feed trace 144 as well as the through-hole to surface mount PCB ground plane 146 may be placed in electrical communication with the surface mount to surface mount spacer PCB 150 via, for example, a solder reflow process. The surface mount to surface mount spacer PCB 150 also includes a surface mount to surface mount spacer PCB feed 152. The surface mount to surface mount spacer PCB feed 152 may be resident on both the top surface and the bottom surface of the surface mount to surface mount spacer PCB 150. In some implementations, the surface mount to surface mount spacer PCB feed 152 may also reside on an interior surface of the surface mount to surface mount spacer PCB 150, thereby placing the top surface in electrical communication with the bottom surface. In addition to, or alternatively from the surface mount to surface mount spacer PCB feed 152 residing on an interior surface of the surface mount to surface mount spacer PCB 150, the top and bottom surface may be in communication with one another via one or more via traces. The surface mount to surface mount spacer PCB 150 may also include a surface mount to surface mount spacer PCB ground plane 154. Similar to the surface mount to surface mount spacer PCB feed 152, the surface mount to surface mount spacer PCB ground plane 154 may reside on both the top and bottom surfaces of the surface mount to surface mount spacer PCB 150. Additionally, the surface mount to surface mount spacer PCB ground plane may also reside on an interior surface of the surface mount to surface mount spacer PCB 150, thereby placing the top surface in electrical communication with the bottom surface. In addition to, or alternatively from the surface mount to surface mount spacer PCB ground plane 154 residing on an interior surface of the surface mount to surface mount spacer PCB 150, the top and bottom surface may be in communication with one another via one or more via traces. The surface mount to surface mount spacer PCB feed 152 as well as the surface mount to surface mount spacer PCB ground plane 154 may be placed in electrical communication with the external connection PCB 160 via, for example, a solder reflow process. The surface mount to surface mount spacer PCB feed 152 and/or the surface mount to surface mount spacer PCB ground plane 154 may consist of a continuous metallization, discrete shapes (e.g., square pads, circular pads, rectangular pads), or combinations of the foregoing.

As shown in FIG. 1C, the external perimeter of the surface mount to surface mount spacer PCB 150 is square in shape. However, other variations for the surface mount to surface mount spacer PCB 150 may have a rectangular profile, a triangular profile, a circular profile, various convex polygonal profiles (e.g., octagonal, irregular convex polygon, hexagonal, etc.) and the like. In some implementations, the surface mount to surface mount spacer PCB 150 may have an external profile that is the same as the through-hole to surface mount PCB 140. These and other variations would be readily apparent to one of ordinary skill given the contents of the present disclosure. The surface mount to surface mount spacer PCB 150 may consist of two conductive layers of material. As shown in FIG. 1C, the central opening of the surface mount to surface mount spacer PCB 150 is square in shape; however, in some variants, other geometries for the central opening may be used dependent on the needs of, for example, the electronic components 170 disposed within the central opening and/or considerations for the mechanical robustness of the surface mount to surface mount spacer PCB 150. See, for example, FIG. 1D.

The external connection PCB 160 includes one (or more) external connection PCB feed pads 162 and one (or more) external connection PCB ground pads 164. As shown in FIG. 1C, the number of external connection PCB feed pads 162 is one, and the number of external connection PCB ground pads 164 is eight, although different numbers of feed pads 162 and ground pads 164 may be used in alternative implementations. The external connection PCB feed pad 162 may be placed in communication with the top surface of the external connection PCB 160 via one (or more) through-hole vias. Similarly, the external connection PCB ground pads 164 may be placed in communication with the top surface of the external connection PCB 160 via one (or more) through-hole vias. In some implementations (not shown), the external connection PCB feed pad 162 and the external connection PCB ground pads 164 may be placed in communication with the top surface of the external connection PCB 160 via traces that run along the outer surface of the external connection PCB 160. The external connection PCB 160 may be secured to the surface mount to surface mount spacer PCB through a solder reflow process. Additionally, the external connection PCB may be secured to a system level PCB through a solder reflow process as well. As shown in FIG. 1C, the external perimeter of the external connection PCB 160 is square in shape. However, other variations for the external connection PCB 160 may have a rectangular profile, a triangular profile, a circular profile, various convex polygonal profiles (e.g., octagonal, irregular convex polygon, hexagonal, etc.) and the like. In some implementations, the external connection PCB 160 may have an external profile that is the same as the through-hole to surface mount PCB 140 and the surface mount to surface mount spacer PCB 150. These and other variations would be readily apparent to one of ordinary skill given the contents of the present disclosure. The external connection PCB 160 may include two or more layers of conductive material. For example, the external connection PCB 160 may consist of eight layers of conductive material. In some implementations, the outer dimensions of the external connection PCB 160 may be larger in dimension than the surface mount to surface mount spacer PCB 150.

Referring now to FIG. 1D, an alternative implementation of the surface mount to surface mount spacer PCB 150 is shown and described in detail. As illustrated, this alternative implementation of the surface mount to surface mount spacer PCB 150 obviates the need for the through-hole to surface mount PCB 140 illustrated in FIG. 1A-1C, although it would be readily apparent to one of ordinary skill given the contents of the present disclosure that the implementation of the surface mount to surface mount spacer PCB 150 may be used in combination with a through-hole to surface mount PCB 140 in some variants. In the embodiment depicted in FIG. 1D, the central opening of the surface mount to surface mount spacer PCB 150 includes a generally octagonal shape. A feed structure 158 is also present within the central opening of the surface mount to surface mount spacer PCB 150. In the central portion of the surface mount to surface mount spacer PCB 150, a castellated hole 156 is present. The height of the portion of the through-hole patch antenna terminal 110 received within the central opening of the surface mount to surface mount spacer PCB 150 is smaller in dimension than the thickness of the feed structure 158 of the surface mount to surface mount spacer PCB 150 to, inter alia, prevent the through-hole patch antenna terminal from shorting to the external connection PCB 160 or any electronic components 170 disposed adjacent to the through-hole patch antenna terminal 110. As illustrated in FIG. 1D, the surface mount to surface mount spacer PCB feed 152 also consists of a castellated hole. This surface mount to surface mount spacer PCB feed 152 is also in electrical communication with the castellated hole 156 via one (or more) traces present on the top surface and/or bottom surface of surface mount to surface mount spacer PCB 150. The surface mount to surface mount spacer PCB feed 152 may be connected with the external connection PCB 160 via a soldered connection. In some implementations, the external connection PCB 160 may also be obviated and the antenna module 100 may be connected to a system level PCB. In such an implementation, antenna module 100 may be connected to a coaxial cable and/or the system level PCB could accommodate the electronic circuitry 170 that would otherwise be disposed on the external connection PCB 160. In implementations which do not contain an external connection PCB 160, the surface mount to surface mount spacer PCB 150 may be connected to a system level PCB through a surface mounting process.

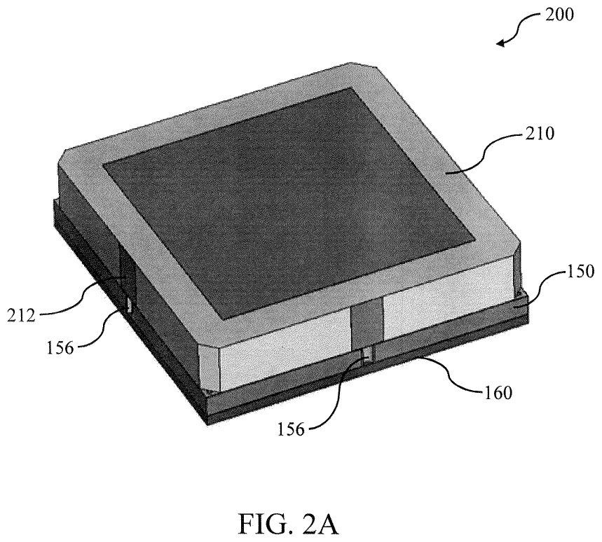

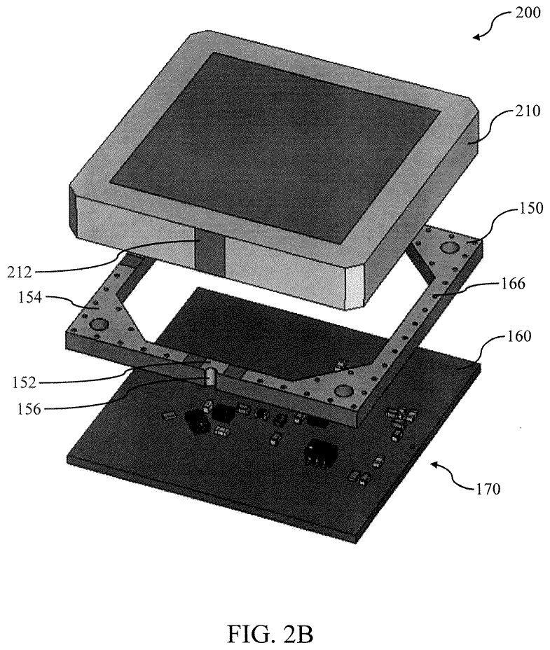

Referring now to FIG. 2A, a perspective view of a surface mount stacked antenna module 200 is shown while in FIG. 2B, an exploded perspective view of the surface mount stacked antenna module 200 is shown. The exemplary surface mount stacked antenna module 200 includes a surface mount patch antenna 210, a surface mount to surface mount spacer PCB 150, and an external connection PCB 160 having a number of electronic components 170 disposed thereon. The electronic components 170 disposed on, for example, the external connection PCB 160 may consist of active and/or passive electronic components 170. These active and/or passive electronic components 170 may operate as the RF module circuitry for the surface mount patch antenna 210. The RF module circuitry may be used for transmission and/or reception circuitry for the surface mount patch antenna 210. The surface mount to surface mount spacer PCB 150, and the external connection PCB 160 may be manufactured from a rigid or semi-rigid PCB. The surface mount patch antenna 210 may include one or more surface mount patch antenna feeds 212, while the surface mount to surface mount spacer PCB 150 may include one or more castellated holes 156. The one or more surface mount patch antenna feeds 212 may be connected to the one or more castellated holes 156 through soldering techniques such as surface mount solder reflow, hand soldering and the like. The one or more castellated holes 156 may also be connected to, for example, the external connection PCB 160 through soldering techniques such as surface mount solder reflow, hand soldering and the like. These connections may be made sequentially or simultaneously.

The surface mount to surface mount spacer PCB 150 provides a clearance area to accommodate the electronic components 170 disposed on the external connection PCB 160. The surface mount patch antenna feed 212 may be placed in electrical communication with the surface mount to surface mount spacer PCB 150 via, for example, a solder reflow process. The surface mount to surface mount spacer PCB 150 also includes a surface mount to surface mount spacer PCB feed 152. The surface mount to surface mount spacer PCB feed 152 will be resident on both the top surface and the bottom surface of the surface mount to surface mount spacer PCB 150. In some implementations, the surface mount to surface mount spacer PCB feed 152 may also reside on an interior surface of the surface mount to surface mount spacer PCB 150, thereby placing the top surface in electrical communication with the bottom surface. In addition to, or alternatively from the surface mount to surface mount spacer PCB feed 152 residing on an interior surface of the surface mount to surface mount spacer PCB 150, the top and bottom surface may be in communication with one another via one or more via traces. The surface mount to surface mount spacer PCB 150 may also include a surface mount to surface mount spacer PCB ground plane 154. Similar to the surface mount to surface mount spacer PCB feed 152, the surface mount to surface mount spacer PCB ground plane 154 may reside on both the top and bottom surfaces of the surface mount to surface mount spacer PCB 150. Through-hole vias 166 may provide a connection path between the top and bottom surfaces of the surface mount to surface mount spacer PCB 150. The surface mount to surface mount spacer PCB feed 152 as well as the surface mount to surface mount spacer PCB ground plane 154 may be placed in electrical communication with the external connection PCB 160 via, for example, a solder reflow process. The surface mount to surface mount spacer PCB feed 152 and/or the surface mount to surface mount spacer PCB ground plane 154 may consist of continuous metallization, discrete shapes (e.g., square pads, circular pads, rectangular pads), or combinations of the foregoing.

As shown in FIGS. 2A and 2B, the external perimeter of the surface mount to surface mount spacer PCB 150 is square in shape. However, other variations for the surface mount to surface mount spacer PCB 150 may have a rectangular profile, a triangular profile, a circular profile, various convex polygonal profiles (e.g., octagonal, irregular convex polygon, hexagonal, etc.) and the like. In some implementations, the surface mount to surface mount spacer PCB 150 may have an external profile that is the same as (or similar to) the external connection PCB 160. These and other variations would be readily apparent to one of ordinary skill given the contents of the present disclosure. The surface mount to surface mount spacer PCB 150 may consist of two conductive layers of material. As shown in FIG. 2B, the central opening of the surface mount to surface mount spacer PCB 150 is octagonal in shape; however, in some variants, other geometries for the central opening may be used dependent on the needs of, for example, the electronic components 170 disposed within the central opening and/or considerations for the mechanical robustness of the surface mount to surface mount spacer PCB 150.

It will be recognized that while certain aspects of the present disclosure are described in terms of specific design examples, these descriptions are only illustrative of the broader methods of the disclosure and may be modified as required by the particular design. Certain steps may be rendered unnecessary or optional under certain circumstances. Additionally, certain steps or functionality may be added to the disclosed embodiments, or the order of performance of two or more steps permuted. All such variations are considered to be encompassed within the present disclosure described and claimed herein.

While the above detailed description has shown, described, and pointed out novel features of the present disclosure as applied to various embodiments, it will be understood that various omissions, substitutions, and changes in the form and details of the device or process illustrated may be made by those skilled in the art without departing from the principles of the present disclosure. The foregoing description is of the best mode presently contemplated of carrying out the present disclosure. This description is in no way meant to be limiting, but rather should be taken as illustrative of the general principles of the present disclosure. The scope of the present disclosure should be determined with reference to the claims.

1. A patch antenna module, comprising:
one or more patch antennas;
a through-hole to surface mount printed circuit board, the through-hole to surface mount printed circuit board being placed in signal communication with the one or more patch antennas via a through-hole patch antenna terminal;
a spacer printed circuit board having an internal cavity disposed therein, the spacer printed circuit board being placed in signal communication with the one or more patch antennas via a surface mount electrical connection; and
an external connection printed circuit board having a plurality of electronic components disposed thereon, the internal cavity of the spacer printed circuit board accommodating at least a portion of the plurality of electronic components disposed on the external connection printed circuit board.

2. The patch antenna module of claim 1, wherein the external connection printed circuit board further comprises a plurality of surface mount pads for connecting the patch antenna module to an external system level device.

3. The patch antenna module of claim 2, wherein the spacer printed circuit board further comprises a feed structure with a castellated hole, the through-hole patch antenna terminal being mounted within the castellated hole such that the through-hole patch antenna terminal only partially penetrates a thickness of the feed structure.

4. The patch antenna module of claim 1, wherein the one or more patch antennas comprises a top patch antenna and a bottom patch antenna, an external periphery of the top patch antenna being smaller in dimension than an external periphery of the bottom patch antenna.

5. The patch antenna module of claim 4, wherein a thickness of the top patch antenna is smaller in dimension than a thickness of the bottom patch antenna.

6. The patch antenna module of claim 1, wherein the plurality of electronic components comprises a passive radio frequency module.

7. The patch antenna module of claim 1, wherein the plurality of electronic components comprises an active radio frequency module.

8. The patch antenna module of claim 1, wherein the through-hole to surface mount printed circuit board comprises a through-hole termination disposed in a central region of the through-hole to surface mount printed circuit board, the through-hole termination being configured to receive the through-hole patch antenna terminal.

9. The patch antenna module of claim 8, wherein the through-hole to surface mount printed circuit board further comprises an antenna feed trace, the antenna feed trace being in signal communication with the through-hole termination, the antenna feed trace extending from the through-hole termination to an end of the through-hole to surface mount printed circuit board.

10. The patch antenna module of claim 9, wherein a portion of the antenna feed trace disposed adjacent to the end of the through-hole to surface mount printed circuit board is in signal communication with a termination on a top surface of the spacer printed circuit board.

11. The patch antenna module of claim 10, wherein the termination on the top surface of the spacer printed circuit board is in electrical communication with a termination on a bottom surface of the spacer printed circuit board.

12. The patch antenna module of claim 11, wherein the electrical communication between the termination on the top surface of the spacer printed circuit board and the termination on the bottom surface of the spacer printed circuit board comprises a trace disposed on a surface of the internal cavity of the spacer printed circuit board that connects the termination on the top surface with the termination on the bottom surface of the spacer printed circuit board.

13. The patch antenna module of claim 12, wherein the spacer printed circuit board further comprises a feed structure with a castellated hole, the through-hole patch antenna terminal being mounted within the castellated hole such that the through-hole patch antenna terminal only partially penetrates a thickness of the feed structure.

14. The patch antenna module of claim 13, wherein the plurality of electronic components comprises a passive radio frequency module.

15. The patch antenna module of claim 13, wherein the plurality of electronic components comprises an active radio frequency module.

16. The patch antenna module of claim 11, wherein the electrical communication between the termination on the top surface of the spacer printed circuit board and the termination on the bottom surface of the spacer printed circuit board comprises a through hole via that connects the termination on the top surface with the termination on the bottom surface of the spacer printed circuit board.

17. The patch antenna module of claim 16, wherein the spacer printed circuit board further comprises a feed structure with a castellated hole, the through-hole patch antenna terminal being mounted within the castellated hole such that the through-hole patch antenna terminal only partially penetrates a thickness of the feed structure.

18. The patch antenna module of claim 17, wherein the plurality of electronic components comprises a passive radio frequency module.

19. The patch antenna module of claim 17, wherein the plurality of electronic components comprises an active radio frequency module.

20. A method of manufacturing a patch antenna module, the method comprising:
acquiring a patch antenna, a through-hole to surface mount printed circuit board, a spacer printed circuit board, and an external connection printed circuit board;
assembling the patch antenna with the through-hole to surface mount printed circuit board via use of a through-hole patch antenna terminal to create a first sub-assembly;
assembling the spacer printed circuit board to the external connection printed circuit board via a solder reflow process to create a second sub-assembly; and
assembling the first sub-assembly with the second sub-assembly using a soldering operation.
